(19) United States
(12) Patent Application Publication
(10) Pub. No.: US 2008/0154842 A1
(43) Pub. Date: Jun. 26, 2008

(54) ENHANCED RELATIONAL DATABASE MANAGEMENT SYSTEM AND METHOD

(75) Inventors: Matthew Albert Huras, Ajax (CA); Keriley Kay Romanufa, Scarborough (CA); Aamer Sachedina, Queensville (CA)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/613,773

(22) Filed: Dec. 20, 2006

(51) Int. Cl. G06F 17/30

(52) U.S. Cl. 707/2

(57) ABSTRACT

A method to enhance relational database management system resiliency and query operations by minimizing CPU overhead and database page access latency and by facilitating database restoration and query efficiency. The method includes creating a clean database page in a buffer pool of a relational database management system, granting exclusive access to the clean database page within the buffer pool to an application that transitions the clean database page to a dirty database page by altering data store thereon, immediately downgrading exclusive access to the dirty database page to shared access in response to receiving an exclusive access termination request from the application, writing the dirty database page to a physical log, and releasing share access to the dirty database page.

### BACKGROUND OF THE INVENTION

1. Field of the Invention

This invention relates to relational database management systems and methods and more particularly to systems and methods for relational database management system resiliency and time-based query operations.

2. Description of the Related Art

Among the many qualities of a relational database management system (hereinafter “RDBMS”) are resiliency and an ability to perform time-based query operations. Resiliency operations include recording database activity with physical logs, logical logs, and database pages, and using them to restore the database to a particular point in time. Time-based query operations include reconstructing a database page from the physical and logical logs according to a previous point in time to represent the database as it was at that point in time. Though current RDBMS operations enable restoration and time-based query operations, certain problems exist.

For example, when an application initially requests exclusive access to a database page, the RDMBS copies the database page to the physical log before granting access thereto. This decreases the overall efficiency of the RDBMS by creating CPU overhead and database page access latency as the CPU copies the database page to the physical log before the application obtains access to the database page. Furthermore, this approach increases the likelihood that multiple redo operations will be necessary upon restoring the database to a particular point in time or reconstructing a database page in a time-base query operation because the database page is copied to the physical log before the application makes any changes thereon.

From the foregoing discussion, applicant asserts that a need exists for a system and method that enhances relational database management system resiliency and query operations. Beneficially, such a method would minimize CPU overhead and database page access latency, and facilitate database restoration and database page reconstruction efficiency by reducing the number of necessary redo operations.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of an enhanced relational database management system in accordance with the present invention; and

FIG. 2 is a schematic flow chart diagram illustrating one embodiment of a method to enhance a relational database management system by minimizing CPU overhead and database page access latency and by facilitating database restoration and database page reconstruction efficiency.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code lines, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

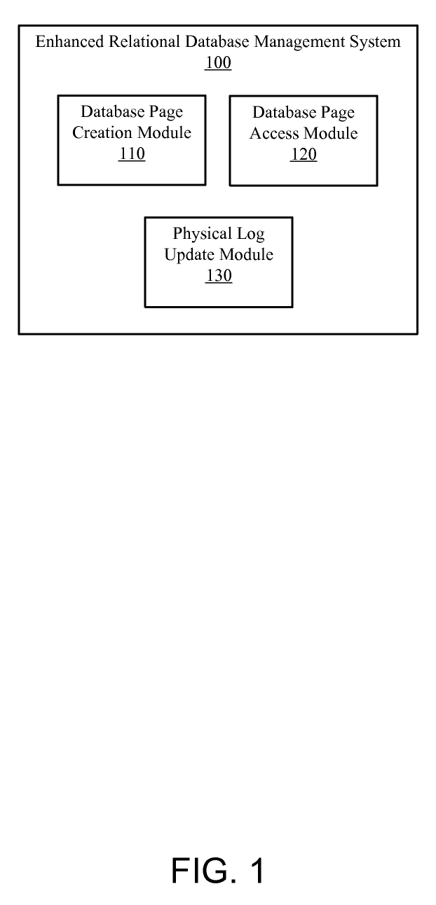

FIG. 1 is a block diagram illustrating one embodiment of an enhanced relational database management system 100 (hereinafter “RDBMS”) in accordance with the present invention. The depicted RDBMS 100 includes a database page creation module 110, a database page access module 120, and a physical log update module 130. The various components of the RDBMS 100 cooperate to enhance RDBMS resiliency operations by minimizing CPU overhead, minimizing database page access latency, and facilitating database restoration and database page reconstruction efficiency.

The database page creation module 110 creates a clean database page in a buffer pool (not shown) of the relational database management system 100. The a clean database page is typically buffered from non-volatile storage. The database page access module 120 grants exclusive access to the clean database page to an application (not shown) in response to receiving an exclusive access request corresponding to the clean database page from the application. Granting exclusive access to the database page without prerequisite operations such as copying the database page to the physical log reduces CPU overhead and minimizes database page access latency thereby contributing to a more efficient relational database management system.

The application transitions the clean database page to a dirty database page by altering the data on the clean database page. The access management module 120 immediately downgrades exclusive access to the dirty database page to shared access in response to receiving an exclusive access termination request from the application. Immediately downgrading the exclusive access to shared access prohibits other applications from gaining exclusive access to the dirty database page.

The physical log update module 130 writes the dirty database page to a physical log of the RDBMS, once the downgrade to shared access is completed. The access management module 120 releases shared access to the dirty database page once the database page is written to the physical log. Writing database pages to the physical log after the application makes changes thereon reduces the number of redo operations that will likely be necessary should a database restoration need to be performed. Similarly, one skilled in the art will realize that reconstruction of a database page as part of a time-based query operation is similarly facilitated.

The schematic flow chart diagram that follows is generally set forth as logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

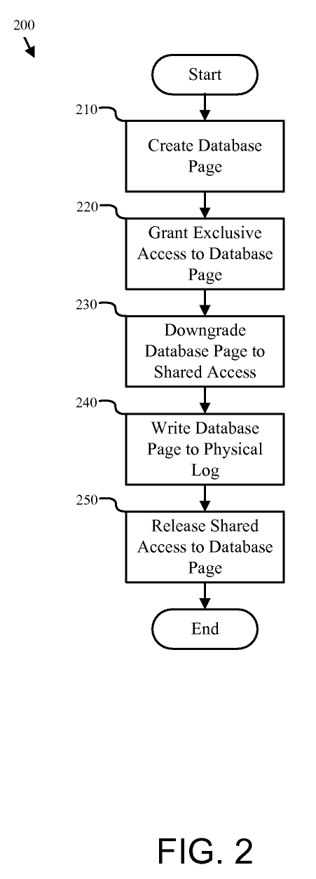

FIG. 2 is a schematic flow chart diagram illustrating one embodiment of a method 200 to enhance a RDBMS by minimizing CPU overhead and database page access latency and by facilitating database restoration and database page reconstruction efficiency. The method 200 depicted in FIG. 2 substantially includes the steps to carry out the functions presented above with respect to the operation of the described enhanced relational database management system. In one embodiment, the method 200 is implemented with a computer program product comprising a computer readable medium having a computer readable program. The enhanced relational database management system 100 may execute the computer readable program.

The method begins and the database page creation module 110 creates 210 a clean database page in a buffer pool of the relational database management system 100. One skilled in the art will recognize that the buffer pool includes volatile memory for caching databases pages and a clean database page includes a database page that reflects the current data in the non-volatile storage to which the database page corresponds. An application may then communicate an exclusive access request to the RDBMS 100 corresponding to the clean database page which is immediately granted 220 by the database page access module 120 without any intermediate operations contributing to system latency and CPU overhead.

Once the application has exclusive access of the clean database page, the application may add, edit, or delete data on the database page, thereby dirtying the database page. When the application no longer requires exclusive access to the database page, the application then notifies the RDBMS accordingly. The database page access module 120 then downgrades 230 the exclusive access status to the database page to a shared access status thereby eliminating the possibility for other applications to gain exclusive access to the database page and alter the data thereon. The physical log update module 130 may then write 240 the dirty database page to a physical log of the RDBMS 100. Other applications may gain shared access to the database page while the page is being written to the physical log of the RDBMS 100. Once the dirty database page is written to the physical log, the access management module 120 then releases 250 shared access to the dirty database page, whereupon a subsequent exclusive access request may be received and granted.

Under certain circumstances, an additional application may request exclusive access to the dirty database page while the RDBMS is holding the dirty database page in shared access for purposes of writing the dirty database page to the physical log. Under such circumstances, the RDBMS may create an in memory copy of the dirty database page and grant exclusive access of the in memory copy to the requesting application. Once, the original dirty database page is written to the physical log, the original dirty database page is discarded and replaced by the in memory copy as the original dirty database page will not include the alterations effected by the additional application.

Under other circumstances, one or more additional applications may request shared access of the dirty database page while the dirty database page is held in shared access for purposes of writing the dirty database page to the physical log. Under such circumstances the RDBMS may grant shared access to the additional application, whereby the additional application may view the dirty database page which includes the changes effected by the previous application. If a third application requests exclusive access to the dirty database page while the dirty database page is shared by the additional application, the third application must wait until the additional application releases shared access of the dirty database page. If the dirty database page has still not been written to the physical log when the additional application releases shared access, then the RDBMS may proceed with the forgoing operations regarding creation of an in memory copy.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product to enhance relational database management system; resiliency operations by minimizing CPU overhead and database page access latency and by facilitating database restoration efficiency, wherein the computer program product when executed on a relational database management system causes the relational database management system to:
create a clean database page in a buffer pool of the relational database management system, wherein the buffer pool comprises volatile memory for caching database pages;
grant exclusive access to the clean database page within the buffer pool to an application in response to receiving an exclusive access request corresponding to the clean database page from the application, wherein the application is configured to alter data stored on the clean database page and thereby convert the clean database page to a dirty database page;
immediately downgrade exclusive access to the dirty database page to shared access in response to receiving an exclusive access termination request from the application;
write the dirty database page to a physical log of the relational database management system, wherein the physical log comprises non-volatile memory of the relational database management system; and
release shared access to the dirty database page after the database page is written to the physical log.

2. The computer program product of claim 1, wherein the computer readable program is further configured to cause the relational database management system to write the dirty database page to the physical log in accordance with a user selected write policy configured to designate an appropriate time for writing the dirty database page to the physical log.

3. The computer program product of claim 1, wherein the computer readable program is further configured to cause the relational database management system to create a volatile memory copy of the dirty database page and grant exclusive access of the volatile memory copy to an additional application if an exclusive access request corresponding to the dirty database page is received from the additional application after the dirty database page is downgraded to shared access, wherein the volatile memory copy of the dirty database page replaces the dirty database page after the dirty database page is written to the physical log.

4. An enhanced relational database management system that minimizes CPU overhead and database page access latency and facilitates database restoration efficiency, the system comprising:
a database page creation module configured to create a clean database page in a buffer pool of the relational database management system, wherein the buffer pool comprises volatile memory for caching database pages;
an access management module configured to grant exclusive access to the clean database page within the buffer pool to an application in response to receiving an exclusive access request corresponding to the clean database page from the application, wherein the application is configured to alter data stored on the clean database page and thereby convert the clean database page to a dirty database page;
the access management module further configured to immediately downgrade exclusive access to the dirty database page to shared access in response to receiving an exclusive access termination request from the application; and
a physical log update module configured to write the dirty database page to a physical log of the relational database management system, wherein the physical log comprises non-volatile memory of the relational database management system;
the access management module further configured to release shared access to the dirty database after the database page is written to the physical log.

5. The system of claim 4, wherein the access management module is further configured to grant shared access to the dirty database page to an additional application if a shared access request corresponding to the dirty database page is received from the additional application after the dirty database page is downgraded to shared access by the database management module.

6. The system of claim 4, wherein the database page creation module is further configured to create a volatile memory copy of the dirty database page and grant exclusive access of the volatile memory copy to an additional application if an exclusive access request corresponding to the dirty database page is received from the additional application after the dirty database page is downgraded to shared access, wherein the volatile memory copy of the dirty database page replaces the dirty database page after the dirty database page is written to the physical log.
